(19) United States
(12) Patent Application Publication
(10) Pub. No.: US 2011/0181825 A1
(43) Pub. Date: Jul. 28, 2011

(54) LIQUID CRYSTAL DISPLAY

(75) Inventor: Han-Na MA, Yongin-city (KR)

(73) Assignee: Samsung Mobile Display Co., Ltd., Yongin-city (KR)

(21) Appl. No.: 12/946,783

(22) Filed: Nov. 15, 2010

(30) Foreign Application Priority Data
Jan. 28, 2010 (KR) 10-2010-0008019

(51) Int. Cl. G02F 1/1339

(52) U.S. Cl. 349/155

(57) ABSTRACT

A liquid crystal display (LCD) is disclosed. The LCD includes a pair of substrates facing each other, a plurality of pixels positioned between the pair of substrates, each pixel comprises a plurality of sub-pixels, a common electrode, a plurality of sub-pixel electrodes opposing the common electrode, a liquid crystal cell defined by the common electrode and the plurality of opposing sub-pixel electrodes, a first spacer formed between the common electrode and at least part of the plurality of sub-pixel electrodes, where the first spacer is configured to maintain a thickness of the liquid crystal cell, where the first spacer extends in a direction over at least two sub-pixels from among the plurality of sub-pixels.

### CROSS-REFERENCE TO RELATED APPLICATIONS

This application claims the benefit of Korean Patent Application No. 10-2010-0008019, filed on Jan. 28, 2010, in the Korean Intellectual Property Office, the disclosure of which is incorporated herein in its entirety by reference.

### BACKGROUND

1. Field

The present disclosure relates to a liquid crystal display, and more particularly, to a liquid crystal display in which a cell gap between substrates can be stably maintained and a sufficient liquid crystal margin can be ensured.

2. Description of the Related Technology

In general, liquid crystal displays (LCDs) include a spacer for supporting a cell gap in order to maintain a predetermined volume between a thin film transistor (TFT) and a color filter. The spacer includes a ball spacer and a column spacer. As glass substrates become thinner, a cell gap cannot be maintained during a pressing process performed on a liquid crystal panel when using a ball spacer, and thus defects, such as spots, are generated. Accordingly, a column spacer, that is generally more stable than a ball spacer, has attracted much attention.

In order to use a column spacer, a space for the column spacer should be formed in a sub-pixel, thereby resulting in a reduction in size of an opening. In particular, in order to realize a display having a high resolution, the size of a sub-pixel is decreasing, and thus a technical method for the reduction of the size of the opening needs to be considered.

In addition, in order to improve mobility of a liquid crystal layer, research into a method capable of disposing a via hole and a column spacer to overlap with each other has recently been conducted. However, the column spacer is depressed into the via hole, and thus a cell gap cannot be maintained.

### SUMMARY OF CERTAIN INVENTIVE ASPECTS

One aspect is a liquid crystal display (LCD) including: a pair of substrates facing each other, a plurality of pixels positioned between the pair of substrates, each pixel includes a plurality of sub-pixels, a common electrode, a plurality of sub-pixel electrodes opposing the common electrode, a liquid crystal cell defined by the common electrode and the plurality of opposing sub-pixel electrodes, and a first spacer formed between the common electrode and at least part of the plurality of sub-pixel electrodes, where the first spacer is configured to maintain a thickness of the liquid crystal cell, where the first spacer extends in a direction over at least two sub-pixels from among the plurality of sub-pixels.

Another aspect is an LCD including: first and second substrates facing each other, a plurality of gate lines and a plurality of data lines configured to cross each other, a TFT configured to perform a switching operation of one of the sub-pixels, and is electrically connected to one of the gate lines and one of the data lines, a common electrode, a sub-pixel electrode associated with one of the sub-pixels and opposing the common electrode, an insulating layer between the TFT and the sub-pixel electrode, a via hole formed into the insulating layer, and a spacer formed between the first and second substrates and configured to maintain a distance between the common electrode and the sub-pixel electrode, where the spacer includes a concave portion that is located corresponding to the via hole.

According to an aspect of the present invention, there is provided an LCD comprising a plurality of sub-pixels and displaying an image, the LCD including: one pair of substrates facing each other; and a spacer formed between the one pair of substrates so as to maintain a distance therebetween, in order to ensure a space in which a liquid crystal layer is formed, wherein the spacer is continuously formed over at least two sub-pixels from among the plurality of sub-pixels.

The spacer continuously may extend over three sub-pixels from among the plurality of sub-pixels. The spacer may be formed in units of the three sub-pixels, from among the plurality of sub-pixels, that are disposed adjacent to one another in an arrangement direction of the sub-pixels.

The spacer continuously may extend over two sub-pixels from among the plurality of sub-pixels. The spacer may be formed in units of the two sub-pixels, from among the plurality of sub-pixels, that are disposed adjacent to one another in an arrangement direction of the sub-pixels.

For example, the LCD may further include a plurality of gate lines and a plurality of data lines that are arranged to cross each other on the substrate, and a thin film transistor (TFT) for performing a switching operation of the sub-pixel and the TFT may be formed in a region where the gate line and the data line cross each other.

The LCD may further include a pixel electrode formed in each of the sub-pixels, an organic insulating layer covering a TFT, and a via hole formed by removing a part of the organic insulating layer and for electrically connecting the pixel electrode and the TFT.

The spacer may extend to cross the via hole, and may include a concave portion formed to correspond to the via hole. For example, the concave portion having a first thickness may be formed to correspond to the via hole in an extending direction of the spacer, and the spacer may include a convex portion having a second thickness, which is greater than the first thickness, may be formed between the concave portions.

For example, the one pair of substrates may be adhered to each other through the convex portion and are supported by each other through the convex portion.

For example, the concave portion may be defined by one pair of inclined surfaces and is formed to face the via hole. At this time, the one pair of inclined surfaces may be inclined in a direction away from the via hole so that the inclined surfaces converge on each other.

According to another aspect of the present invention, there is provided an LCD comprising a plurality of sub-pixels and displaying an image, the LCD including: first and second substrates facing each other; a plurality of gate lines and a plurality of data lines extending in directions in which the gate lines and the data lines cross each other on the first substrate; a TFT for performing a switching operation of the sub-pixel and the TFT is formed in a region where the gate line and the data line cross each other; a pixel electrode formed to correspond to the sub-pixel; an organic insulating layer formed between the TFT and the pixel electrode; a via hole formed by removing a part of the organic insulating layer and for electrically connecting the pixel electrode and the TFT; and a spacer formed between the first and second substrates so as to maintain a distance therebetween in order to ensure a space in which a liquid crystal layer is formed, wherein a the spacer includes concave portion is formed to be depressed so as to correspond to the via hole of the spacer.

For example, the spacer may extend to cross the via hole, a concave portion having a first thickness may be formed to correspond to the via hole, and may include a convex portion having a second thickness, which is greater than the first thickness, may be formed between the concave portions.

For example, the first and second substrates may be adhered to each other through the convex portion and may be supported by each other through the convex portion.

For example, the concave portion may be defined by one pair of inclined surfaces and may be formed to face the via hole. At this time, the one pair of inclined surfaces may be inclined in a direction away from the via hole so that the inclined surfaces converge on each other.

For example, the spacer continuously may extend over at least two sub-pixels from among the plurality of sub-pixels. In more detail, the spacer may be formed in units of three sub-pixels, from among the plurality of sub-pixels, that are disposed adjacent to one another in an arrangement direction of the sub-pixels, or the spacer may be formed in units of two sub-pixels, from among the plurality of sub-pixels, that are disposed adjacent to one another in an arrangement direction of the sub-pixels.

### BRIEF DESCRIPTION OF THE DRAWINGS

The above and other features and advantages will become more apparent by describing in detail certain exemplary embodiments with reference to the attached drawings in which:

FIG. 1 is a plane view illustrating arrangement of a spacer in a liquid crystal display (LCD), according to an embodiment of the present invention;

FIG. 2 is a cross-sectional view taken along line II-II of FIG. 1;

FIG. 3 is a cross-sectional view taken along line of FIG. 1;

FIG. 4 is a plane view illustrating arrangement of a spacer in an LCD according to a comparative example;

FIG. 5 is a cross-sectional view taken along line V-V of FIG. 4;

FIG. 6 is a plane view illustrating arrangement of a spacer in an LCD, according to another embodiment of the present invention; and

FIG. 7 is a cross-sectional view taken along line VII-VII of FIG. 6.

### DETAILED DESCRIPTION OF CERTAIN INVENTIVE EMBODIMENTS

Hereinafter, a liquid crystal display (LCD) according to certain embodiments of the present invention will be described in detail with reference to the attached drawings.

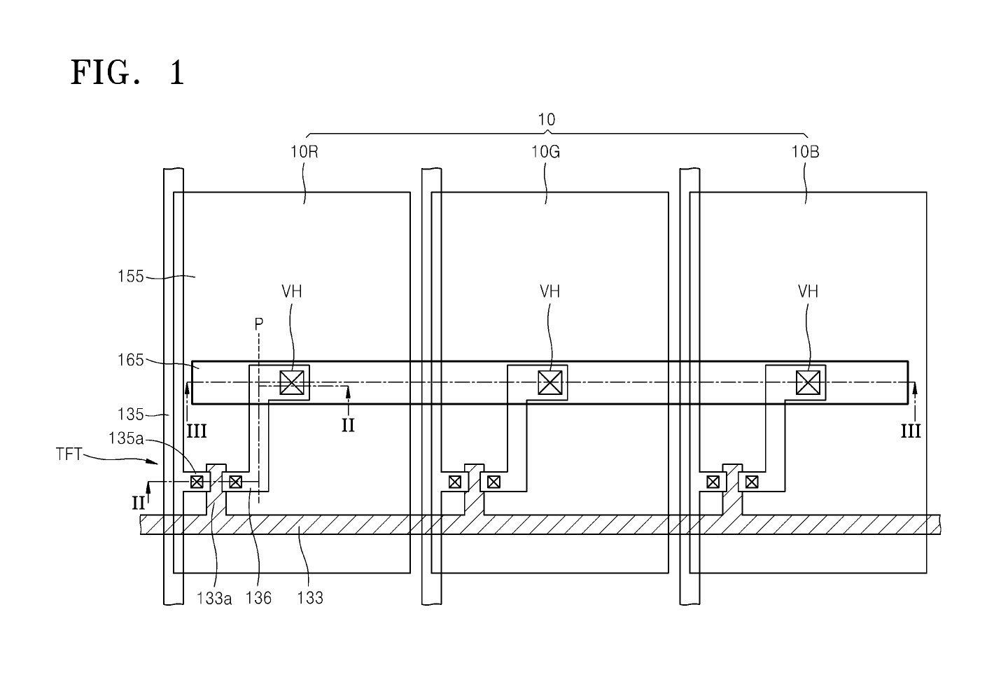

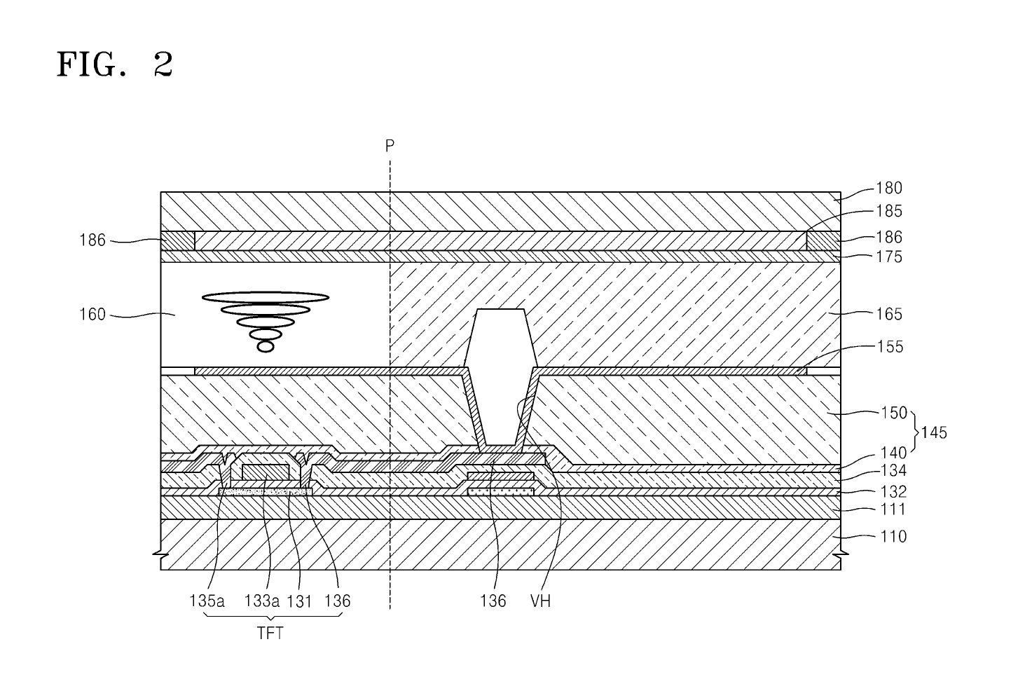

FIG. 1 is a plane view illustrating a schematic layout of an LCD, according to an embodiment of the present invention. FIG. 2 is a cross-sectional view taken along line II-II of FIG. 1.

Referring to FIGS. 1 and 2, a first substrate 110 and a second substrate 180 face each other. A plurality of data lines 135 and a plurality of gate lines 133 are arranged to cross each other on the first substrate 110, as illustrated in FIG. 1. For example, each of sub-pixels 10R (red), 10G (green) and 10B (blue) is surrounded by the data line 135 and the gate line 133, and the sub-pixels 10R, 10G and 10B may be combined to form one pixel 10.

A thin film transistor (TFT) is disposed in a portion where the data line 135 and the gate line 133 cross each other, so as to perform an on/off switching operation of each of the sub-pixels 10R, 10G and 10B. A gate electrode 133a of the TFT is connected to the gate line 133, a source electrode 135a is connected to the data line 135, and a drain electrode 136 is connected to a pixel electrode 155. A data signal of the data line 135 is applied to the pixel electrode 155 according to a signal applied to the gate line 133. The pixel electrode 155 may be formed to correspond to each of the sub-pixels 10R, 10G and 10B and may be electrically connected to the drain electrode 136 through a via hole VH. The via hole VH may be formed by removing an organic insulating layer 145 corresponding to the via hole VH through a photolithography method.

The sub-pixels 10R, 10G and 10B are arranged in a row in the LCD, and a spacer 165 is continuously formed so as to cross the sub-pixels 10R, 10G and 10B. The spacer 165 is formed between the first and second substrates 110 and 180 which face each other so as to maintain a predetermined distance therebetween, in order to ensure a space in which a liquid crystal layer 160 is formed, as will be described later.

As illustrated in FIG. 1, in some embodiments, a single spacer 165 may extend over the three sub-pixels 10R, 10G and 10B. In other embodiments, the spacer may be divided in units of the pixel 10. The spacer 165 may thus include a plurality of spacers 165 spaced apart from one another. Thus, when the liquid crystal layer 160 is formed by dropping a liquid crystal and then compressing the first and second substrates 110 and 180 against each other, the spacer 165 does not act as an obstacle, and consequently, a liquid crystal dispersion effect is not reduced.

Referring to FIG. 2, in the LCD, a buffer layer 111 is formed on the first substrate 110. The buffer layer 111 ensures flatness of the first substrate 110 and is formed to prevent impurities from being discharged.

An active layer 131 is formed on the buffer layer 111 in a predetermined pattern. A gate insulating layer 132 is formed on the active layer 131. A gate electrode 133a is formed on the gate insulating layer 132 in a predetermined pattern. An interlayer insulating layer 134 is formed on the gate electrode 133a so as to cover the gate electrode 133a. After the interlayer insulating layer 134 is formed, the gate insulating layer 132 and the interlayer insulating layer 134 are etched through a dry etching process so as to expose the active layer 131, thereby forming a contact hole. A source electrode 135a and a drain electrode 136 are formed to be electrically connected to the active layer 131 through the contact hole.

A passivation layer 140 is formed to cover the source electrode 135a and the drain electrode 136. A planarization layer 150 is formed on the passivation layer 140. The passivation layer 140 and the planarization layer 150 may be commonly referred to as the organic insulating layer 145 for covering and insulating the TFT. The via hole VH is formed by etching the organic insulating layer 145, and a pixel electrode 155 is formed in a predetermined pattern so as to be connected to the drain electrode 136 through the via hole VH.

The second substrate 180 is formed to face the first substrate 110. The second substrate 180 may be formed of an optically transparent material, similar to the first substrate 110. The liquid crystal layer 160 is formed between the first substrate 110 and the second substrate 180. A color filter layer 185 is formed under the second substrate 180. The color filter layer 185 represents red, green and blue colors and may be formed to correspond to the sub-pixels 10R, 10G and 10B. A black matrix section 186 may be formed in a region that does not correspond to the sub-pixels 10R, 10G and 10B, under the second substrate 180. A common electrode 175 is formed under the color filter layer 185.

The spacer 165 is formed between the first and second substrates 110 and 180 so as to maintain a predetermined distance therebetween, and the liquid crystal layer 160 is formed in the spacer 165. In some embodiments, the spacer 165 has a predetermined thickness and is fixed adjacent to the second substrate 180. The spacer 165 may continuously extend over the sub-pixels 10R, 10G and 10B arranged in a row, as illustrated in FIG. 1.

A signal of the source electrode 135a is applied to the drain electrode 136, according to a control signal applied to the gate electrode 133a, and transmitted to the pixel electrode 155 via the drain electrode 136. Arrangement of the liquid crystal layer 160 is determined by a potential difference between the common electrode 175 and the pixel electrode 155. Visible light provided from a backlight unit (not shown) is blocked or transmitted according to the arrangement of the liquid crystal layer 160. The transmitted visible light becomes colored while passing through the color filter layer 185, thereby displaying an image.

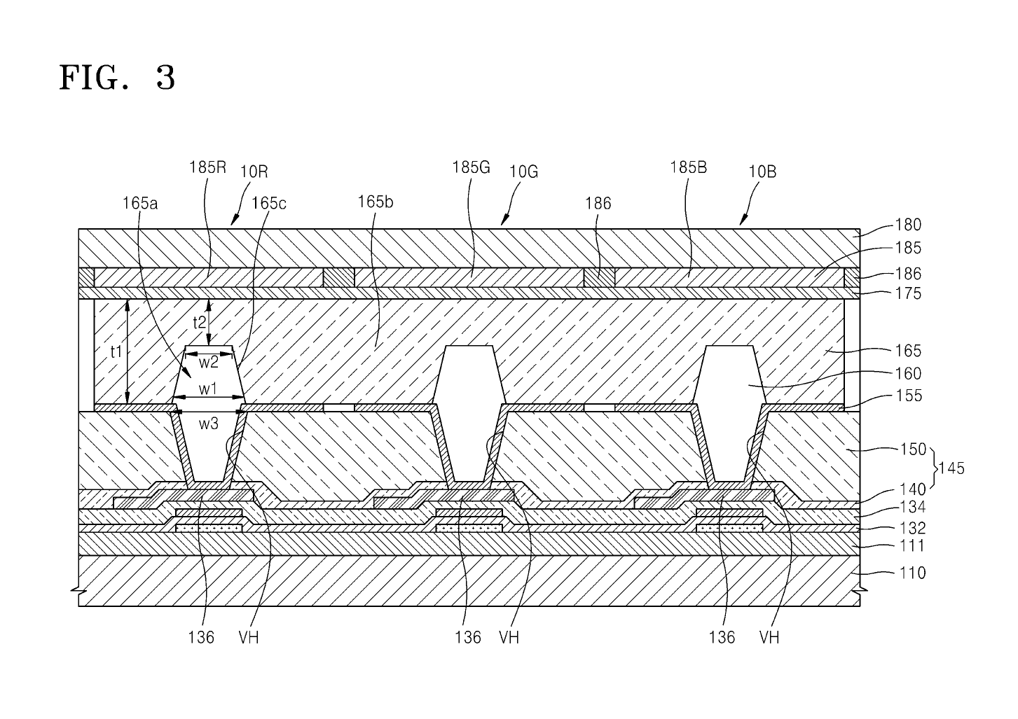

FIG. 3 is a cross-sectional view taken along line of FIG. 1. Referring to FIG. 3, the spacer 165 is formed between the first substrate 110 and the second substrate 180 so as to maintain a predetermined distance therebetween. The spacer 165 extends over the plurality of sub-pixels 10R, 10G and 10B, in a row direction. In some embodiments, the spacer 165 may have a first thickness t 1 and may be formed of an organic material, inorganic material, or resist material.

A plurality of concave portions 165a is formed in the spacer 165 at predetermined intervals in an extending direction of the spacer 165. The concave portion 165a is formed by removing a part of the spacer 165 so as to correspond to the via hole VH of the sub-pixels 10R, 10G and 10B. In some embodiments, after the spacer 165 having a first thickness t 1 is formed, a part of the spacer 165 is etched so as to obtain a second thickness t2, thereby forming the spacer 165 including the concave portion 165a. In other embodiments, the spacers 165 having the first and second thicknesses t1 and t2 may be formed by using a half tone mask capable of defining the concave portion 165a.

The spacer 165 has an inclined surface 165c that is tapered in a thickness direction of the spacer 165 and defines the concave portion 165a and the convex portion 165b alternately. In some embodiments, an opening width w1 of the concave portion 165a may be greater than an upper opening width w2 of the concave portion 165a (w1>w2).

The convex portion 165b of spacer 165 maintains a distance substantially constant between the first and second substrates 110 and 180. More specifically, the convex portion 165b separates the second substrate 180 and its associated components 175, 185, 186 from the planarization layer 150 formed over the first substrate 110. As such, the first and second substrates 110 and 180 are integrated together via the convex portion 165b.

The spacer 165 has a pattern in which the convex portion 165b with first thickness t1 and the concave portion 165a with second thickness t2 are repeated. The spacer 165 ensures that a predetermined cell gap is formed and maintained in the area where the concave portions 165a are provided, so that the liquid crystal layer 160 formed between the first and second substrates 110 and 180 may move freely in the via hole VH. Thus, a distance between the first and second substrates 110 and 180 may be stably maintained by the spacer 165 that is continuously formed and crosses the sub-pixels 10R, 10G and 10B. Also, the concave portion 165a is formed in the spacer 165 so as not to affect spreadability of the liquid crystal layer 160. In some embodiments, the opening width w1 of the concave portion 165a may be the same as or greater than the opening width w3 of the via hole VH (w1>w3).

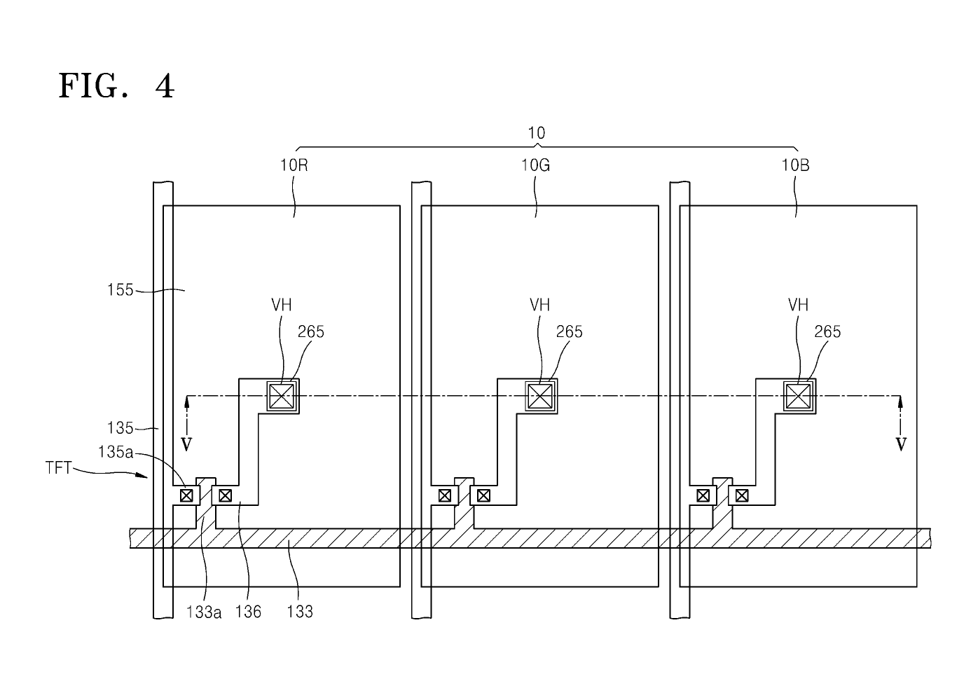

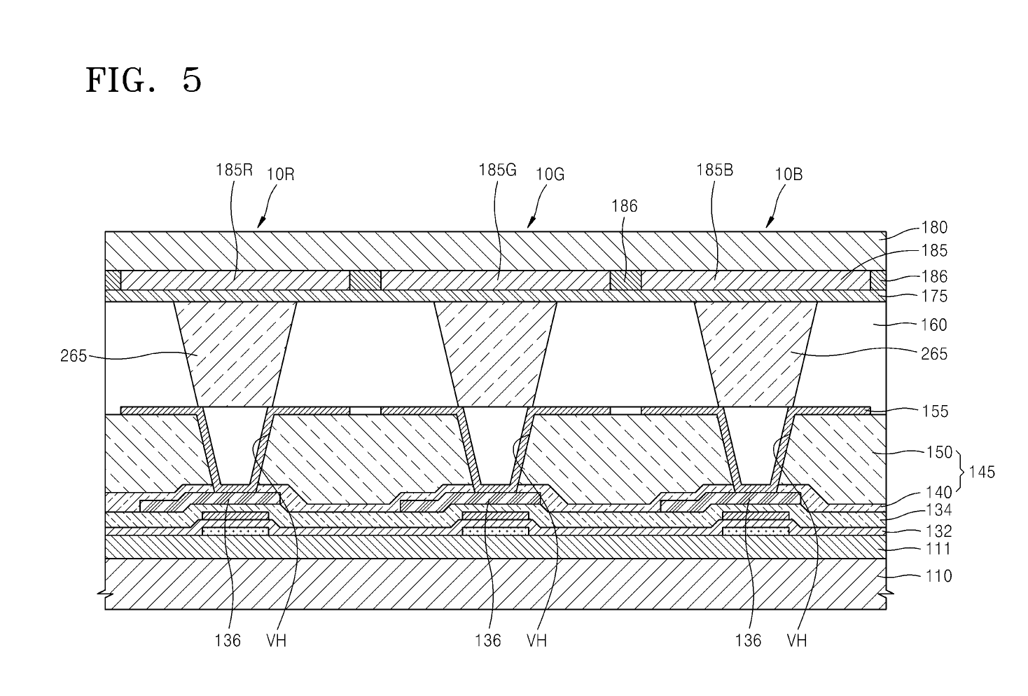

FIG. 4 is a plane view illustrating arrangement of a spacer in an LCD according to a comparative example. FIG. 5 is a cross-sectional view taken along line V-V of FIG. 4.

Referring to FIGS. 4 and 5, a plurality of sub-pixels 10R, 10G and 10B are arranged in a row in the LCD, and an image is displayed by the plurality of sub-pixels 10R, 10G and 10B. A spacer 265 is formed in each of the sub-pixels 10R, 10G and 10B so as to maintain a predetermined distance between first and second substrates 110 and 180 that face each other. The spacer 265 ensures a space where a liquid crystal layer 160 is formed. The spacer 265 does not continuously extend to the adjacent sub-pixel 10R, 10G or 10B and is formed in an isolated state in each of the sub-pixels 10R, 10G and 10B. As seen in FIG. 4, the spacer 265 is narrower than each of the sub-pixels 10R, 10G and 10B.

Referring to FIG. 5, the first and second substrates 110 and 180 face each other across a liquid crystal layer 160 and are bonded together via the spacer 265. The distance between the first and second substrates 110 and 180 is constantly maintained by the spacer 265. A TFT is formed in each of the sub-pixels 10R, 10G and 10B so as to perform on/off switching operations of the corresponding sub-pixel 10R, 10G or 10B. A drain electrode 136 of the TFT is connected to a pixel electrode 155 through a via hole VH.

The spacer 265 is formed to correspond to the via hole VH. When the spacer 265 formed to overlap with the via hole VH is depressed into the via hole VH, the distance between the first and second substrates 110 and 180 can vary and a cell gap may not be supported. Depths of via holes VH are generally greater than 3 μm. When the spacer 265 is depressed into the via hole VH, the spacer 265 needs to have a thickness greater than 6.5 μm in order to maintain a predetermined cell gap. However, it is practically impossible to form the spacer 265 having a thickness greater than 5 μm.

In the embodiment of an LCD shown in FIG. 3, since the spacer 165 for maintaining the distance between the first and second substrates 110 and 180 continuously extends across the three sub-pixels 10R, 10G and 10B, a possibility that the spacer 165 is depressed into the via hole VH formed in each of the sub-pixels 10R, 10G and 10B is completely prevented. Thus, a predetermined distance between the first and second substrates 110 and 180 may be maintained to be constant, thereby maintaining a sufficient thickness of the liquid crystal layer 160.

In some embodiments, the spacer 165 may have a linear form divided at predetermined intervals, instead of a linear form continuously extending as one body. In such embodiments, when the liquid crystal layer 160 is formed by dropping a liquid crystal and then compressing the first and second substrates 110 and 180 against each other, the spacer 165 does not act as an obstacle, and consequently, a liquid crystal dispersion effect is not reduced.

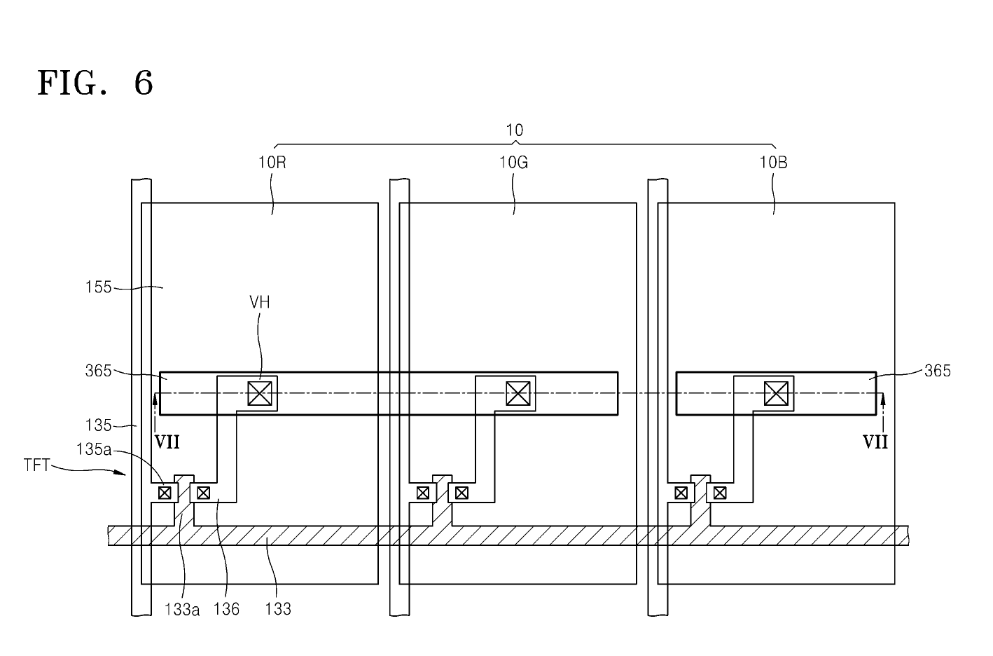

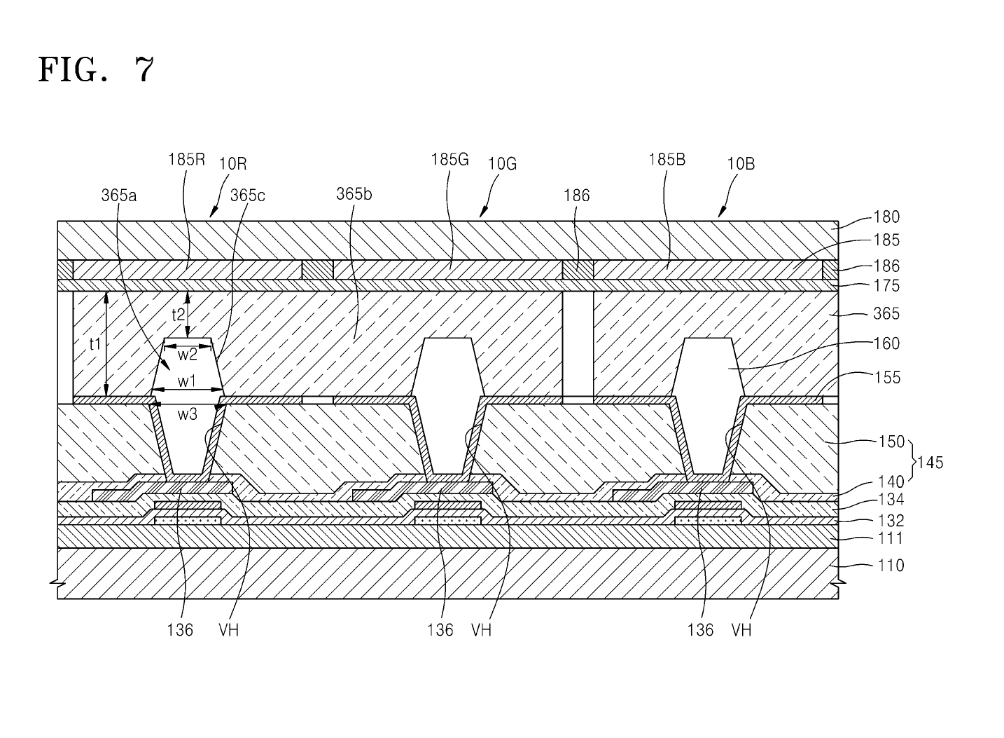

FIG. 6 is a plane view illustrating arrangement of a spacer 365 in an LCD according to another exemplary embodiment of the present invention. FIG. 7 is a cross-sectional view taken along line VII-VII of FIG. 6.

Referring to FIGS. 6 and 7, an embodiment of the LCD may include a plurality of sub-pixels 10R, 10G and 10B arranged in a matrix pattern and may display a predetermined image. The spacer 365 is formed in a direction in which the sub-pixels 10R, 10G and 10B are arranged. In the exemplary embodiment shown, the spacer 365 may extend to cross the two adjacent sub-pixels 10R and 10G.

A TFT is disposed in each of the sub-pixels 10R, 10G and 10B so as to perform on/off switching operations of the sub-pixels 10R, 10G and 10B. A via hole VH is formed in the spacer 365 so as to electrically connect a drain electrode 136 and a pixel electrode 155 of the TFT. In some embodiments, the via hole VH may have a generally square shape. Referring to FIG. 7, a concave portion 365a is formed by etching a part of the spacer 365 so as to correspond to the via hole VH. That is, the spacer 365 has a pattern in which a convex portion 365b having a first thickness t1 and the concave portion 365a having a second thickness t2 are alternately repeated. The spacer 365 is disposed between the first and second substrates 110 and 180 so as to maintain a predetermined distance therebetween through the convex portion 365b. The first and second substrates 110 and 180 are bonded together via the convex portion 365b.

Also, the spacer 365 ensures a predetermined cell gap between the via holes VH through the concave portion 365a, so that the liquid crystal layer 160 formed between the first and second substrates 110 and 180 may move freely in the via hole VH. Thus, a distance between the first and second substrates 110 and 180 may be maintained to be constant by the spacer 365 that is continuously formed and crosses the sub-pixels 10R, 10G and 10B. Also, the concave portion 365a is formed in the spacer 365 so as not to affect spreadability of the liquid crystal layer 160.

In some embodiments, a cell gap between substrates can be maintained to be constant by forming a spacer continuously formed along adjacent sub-pixels. In such embodiments, a concave portion is formed to correspond to a via hole of the spacer, so that a liquid crystal layer formed between substrates can move freely in the via holes, thereby ensuring a sufficient liquid crystal margin. A spacer is disposed in a via hole for connecting a pixel electrode and a thin film transistor, thereby maximizing an aperture ratio of the via hole.

While certain embodiments of the present invention has been particularly shown and described, it will be understood by those of ordinary skill in the art that various changes in form and details may be made without departing from the spirit and scope of the present invention.

What is claimed is:

1. A liquid crystal display (LCD) comprising:
a pair of substrates facing each other;
a plurality of pixels positioned between the pair of substrates, each pixel comprises a plurality of sub-pixels;
a common electrode;
a plurality of sub-pixel electrodes opposing the common electrode;
a liquid crystal cell defined by the common electrode and the plurality of opposing sub-pixel electrodes; and
a first spacer formed between the common electrode and at least part of the plurality of sub-pixel electrodes, wherein the first spacer is configured to maintain a thickness of the liquid crystal cell, wherein the first spacer extends in a direction over at least two sub-pixels from among the plurality of sub-pixels.

2. The LCD of claim 1, wherein the first spacer extends over three sub-pixels from among the plurality of sub-pixels.

3. The LCD of claim 2, wherein the first spacer is longer than a length of one of the plurality of sub-pixels in a direction that the first spacer extends.

4. The LCD of claim 1, wherein the first spacer continuously extends over two sub-pixels from among the plurality of sub-pixels.

5. The LCD of claim 4, wherein the LCD further comprises a second spacer formed between the common electrode and at least part of the plurality of sub-pixel electrodes, wherein the second spacer is configured to maintain the thickness of the liquid crystal cell, wherein the second spacer further extends in the direction with a gap between the first and second spacers.

6. The LCD of claim 1, further comprising a plurality of gate lines and a plurality of data lines configured to cross each other over one of the substrates, and a thin film transistor (TFT) configured to perform a switching operation of a sub-pixel, wherein the TFT is formed in a region where the gate line and the data line cross each other.

7. The LCD of claim 6, further comprising an insulating layer over the plurality of TFTs and further comprising a plurality of via holes recessed into the insulating layer, wherein each of the plurality of sub-pixel electrodes is electrically connected to its associated TFT through one of the plurality of via holes.

8. The LCD of claim 1, further comprising a planarization layer and an array of integrated circuits, which comprises a plurality of thin film transistors and is interposed between the first substrate and the planarization layer, wherein the LCD further comprises a plurality of via holes formed in the planarization layer.

9. The LCD of claim 7, wherein the first spacer extends over at least one via hole.

10. The LCD of claim 9, wherein the first spacer comprises at least one concave portion that is located corresponding to the at least one via hole.

11. The LCD of claim 10, wherein the at least one concave portion of the first spacer is sized corresponding to that of the at least one via hole.

12. The LCD of claim 10, wherein the at least one concave portion is wider than the at least one corresponding via hole measured along the direction.

13. The LCD of claim 10, wherein the first spacer has a first thickness in the at least one concave portion, and the first spacer has a second thickness in a non-concave portion, wherein the second thickness is greater than the first thickness.

14. The LCD of claim 1, wherein the first spacer contacts the common electrode and also contacts at least two sub-pixel electrodes associated with the at least two sub-pixels.

15. The LCD of claim 10, wherein one of the plurality of sub-pixel electrodes is interposed between the planarization layer and the first spacer, wherein the interposed sub-pixel electrode contacts both the planarization layer and the first spacer in a non-concave portion thereof such that the pair of substrates are kept substantially equidistant from one another via the non-concave portion of the first spacer.

16. The LCD of claim 8, wherein the concave portion is defined by a pair of inclined surfaces and faces the via hole, wherein the pair of inclined surfaces is inclined toward each other when viewed in a direction away from the via hole.

17. An LCD comprising:
first and second substrates facing each other;
a plurality of gate lines and a plurality of data lines configured to cross each other;
a TFT configured to perform a switching operation of one of the sub-pixels, and is electrically connected to one of the gate lines and one of the data lines;
a common electrode;
a sub-pixel electrode associated with one of the sub-pixels and opposing the common electrode;
an insulating layer between the TFT and the sub-pixel electrode;
a via hole formed into the insulating layer; and
a spacer formed between the first and second substrates and configured to maintain a distance between the common electrode and the sub-pixel electrode, wherein the spacer comprises a concave portion that is located corresponding to the via hole.

18. The LCD of claim 17, wherein the concave portion of the spacer has a first thickness corresponding to the thickness of the via hole, and a convex portion formed between via holes of consecutive sub-pixels, having a second thickness.

19. The LCD of claim 17, wherein the concave portion is defined by a pair of inclined surfaces and faces the via hole, wherein the pair of inclined surfaces is inclined toward each other when viewed in a direction away from the via hole.

20. The LCD of claim 17, wherein the spacer continuously extends over at least two sub-pixels from among the plurality of sub-pixels.
